(19) United States
(12) Patent Application Publication
(10) Pub. No.: US 2017/0192759 A1
(43) Pub. Date: Jul. 6, 2017

(54) METHOD AND SYSTEM FOR GENERATION OF MACHINE-EXECUTABLE CODE ON THE BASIS OF AT LEAST DUAL-CORE PREDICTIVE LATENCY

(71) Applicant: Robert Keith Mykland, Capitola, CA (US)

(72) Inventor: Robert Keith Mykland, Capitola, CA (US)

(21) Appl. No.: 14/985,723

(22) Filed: Dec. 31, 2015

(51) Int. Cl. G06F 9/45

(52) U.S. Cl. CPC G06F 8/443

(57) ABSTRACT

A computer-enabled method is presented whereby source code is segmented into a unit of work for increased efficiencies in processing by computing systems. A first system latency value of the first processor and a second latency value of the second processor are determined by assigning units of work to the first and second processors, respectively, in view of the workloads of the processors. The system latency values are subsequently compared, and units of computational work are assigned to the first or second processors based on the comparative values of the system latencies of the first and second processors, wherein the computing code comprising the units of work may be rewritten and reassigned between a plurality of processors. Additionally presented is a system by which the invented method may be implemented.

### FIELD OF THE INVENTION

The present invention relates to improvements in attempts to optimize compiled code in a data processing environment. More particularly, the present invention relates to systems and methods for assigning segments of code to one or more distinct processors with the object of improving the performance of resultant optimized code.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Computing systems having one or more processors are ubiquitous today, but the prior art does not provide for automatic and optimizable means by which segments of machine code may be divided into units of work and assigned to a two or more, or a plurality of, processors for execution. Prior art systems infrequently make use of predictive processing because such modeling can place sub-optimal restrictions on processing power. Yet the principle of two or more processors having generally predictive latency can provide improved system performance in an execution of compiled code when effectively provided in a reorganization or recompilation of an initially examined software program.

There is therefore a long-felt need to provide increased efficiencies in systems and methods for the organization of software and raw computing code such that more than one processor may act thereon.

### SUMMARY AND OBJECTS OF THE INVENTION

Towards these objects and other objects that will be made obvious in light of the present disclosure a method is provided whereby compiled code is reorganized and potentially recompiled to run in an environment comprising at least two processors. In a first preferred embodiment of the method of the present invention (hereinafter “invented method”) an initial software code is selected and is incrementally reorganized by selected segments into a resultant software code, whereby the completed resultant software code is reorganized and optionally recompiled to improve system performance when executing the completed resultant software code in comparison to an execution by a same system of the initial software code. It is understood that as each segment is sequentially processed by the invented method, each processed segment is added to a partially completed resultant software code until the entire initial software code is fully processed and the resultant software code is completed.

During the application of the invented method, a first workload is determined for a first processor as determined from the instant partially resultant software code, a second workload is determined for a second processor as determined from the same the instant partially resultant software code, and a subsequent unprocessed segment is selected from the initial software code. It is understood that the initial software code may include commands or instruction codified in a high level software language, such as C++ or Hyper Text Mark-up Language, and/or a machine-executable code, e.g., processor-type specific executable code.

Each segment preferably includes a plurality of software commands, instructions and other software-encoded information comprising a unit of computational work (hereinafter “unit of work”). One or more units of work are sequentially selected from the same initial software code, wherein the unit of work is determined based upon separating the machine code into arbitrarily large and/or small segments od units of work. A first system latency value is subsequently determined by creating a model of the application of the unit of work, i.e., of the segment of the initial software code, to the first processor, while the determined system workload is calculated. A second system latency value is additionally determined by creating a model of the application of the unit of work to the second processor, and the second system latency is calculated. The analyses of the calculated system software latency values between the first scenario and the second scenario are subsequently compared, and the unit of work is assigned to either the first processor or the second processor, based upon which scenario displays a lower calculated system latency value. The machine code comprising the units of work are then preferably divided among and assigned to processors such that the resultant software code takes advantage of a maximum possible system efficiency.

In a further preferred embodiment of the invented method, the compiled resultant software code is run in a multi-core environment enabling data processing, having more than two communicatively coupled processors. An initial workload is assigned to each of the plurality of processors, and an initial software code is accessed according to specific work to be done in the processors. The initial software code may be or include elements of a source code of high-level language commands, elements of a machine-executable code, or a combination of elements thereof. A unit of work is determined by generating machine code segments corresponding to the initial software code, wherein the segments of the machine code comprise the units of work, and a plurality of calculated system latency values are determined in view of a software-encoded performance model of a target system. The plurality of calculated system latency values are determined by sequentially applying a same unit of work to each selected processor of the target system. It is understood that an instant unit of work may, in simulating target system performance in each alternate application of the instant unit of work by a selected processor of the target system, be reorganized or recompiled in view of a particular characteristics of the selected processor in accordance with the software-encoded performance model of the target system and the nature of the selected processor. In calculating a system latency by simulating system performance in the execution of alternate assignments of the instant unit of work to each selected processor of the target system, the software-encoded performance system model is applied to simulate a state of the target system that would be achieved when the entire preceding partial resultant software code had been executed. This preparation of the software-encoded performance model of the target system thus enables the invented method to segment by segment calculate system latencies that would be imposed in view of previous assignments of units of work to various selected processors of the target system The calculated system latency values of each of the plurality of processors is compared in each scenario of assignment to execution by the instant unit of work to each selected processor, and the instant unit of work is assigned to the processor of the plurality of processors of the target system as designated in the target system execution scenario which offers the lowest calculated system latency value.

In an optional alternate embodiment of the invented method, an invented compiler is adapted to perform, and operates as, a just-in-time compiler to generate optimized executable code. More particularly, machine-executable code may be generated by the invented complier and executed by a computer prior to the compiler fully processing the initial software code to generate a resultant software code that expresses all or substantively most of the logic of the initial software code.

A computing system is additionally provided which enables the various embodiments of the invented method. The computing system may contain a compiler that applies the invented method to generate machine-executable software code that is then executed by the same computing system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a network diagram of a plurality of bidirectionally communicatively coupled computers, comprising an “authoring computer” and a plurality of target computers;

FIG. 2 is a block diagram of the authoring computer of FIG. 1;

FIG. 3 is a block diagram of the first target computer of FIG. 1;

FIG. 4 is a flow chart of a preferred embodiment of the invented method;

FIG. 5 a flowchart providing additional detail in the method of FIG. 4;

FIG. 6 is a flowchart depicting the process by which a software encoded performance model of a target computer of FIG. 1 is created and stored for use by the authoring computer of FIGS. 1 and 3; and

FIGS. 7A-7D are block diagrams of a plurality of exemplary matrix records.

### DETAILED DESCRIPTION

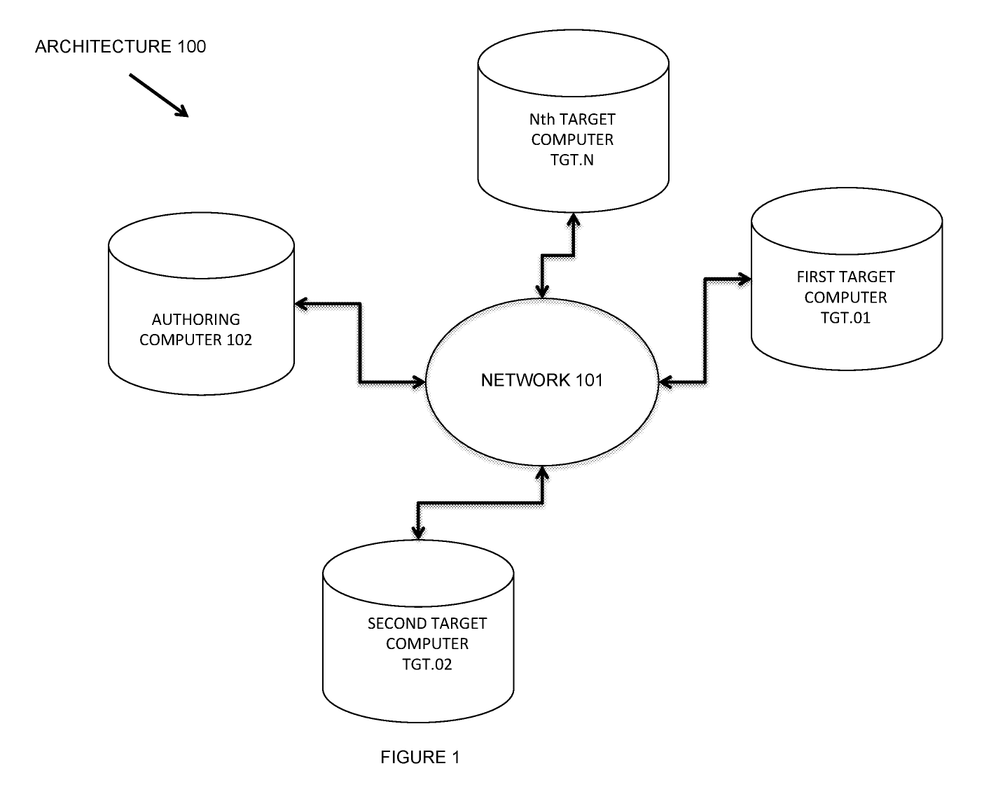

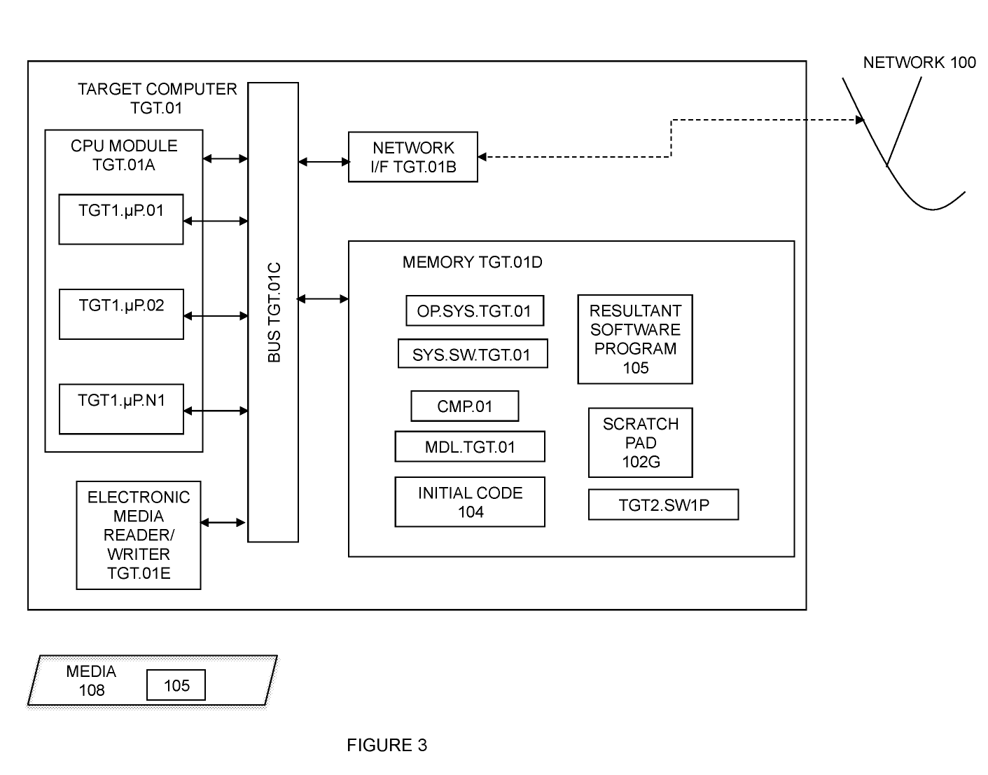

Referring now generally to the Figures and particularly to FIG. 1, FIG. 1 is a network diagram showing an electronic communications network architecture 100 comprising a an electronics communications network 101, an authoring computer 102, a first target computer TGT.01, a second target computer TGT.02, and a plurality of Nth target computers TGT.N. The authoring computer 102 is applied to an initial software code 104 (hereinafter, “initial code” 104) compiled in accordance with invented method to generate a machine-executable resultant software programs 106 & TGT1.SW1-TGTN.SWN (hereinafter, “resultant code” TGT1.SW1-TGTN.SWN), as indicated in FIG. 3. Each computer 102, TGT.01, TGT.02 & TGT.N is preferably bidirectionally communicatively coupled by means of the electronics communications network 101 (“the network” 101). It is understood that the network 101 may be, comprise, or be comprised within, the Internet and/or other suitable communications structures, equipment, or systems known in the art. It is further understood that the value “N” is used within the present disclosure to indicate an arbitrarily large integer value, whereby the number of target computers TGT.01-TGT.N is defined by the actual composition of the electronic communications network 100.

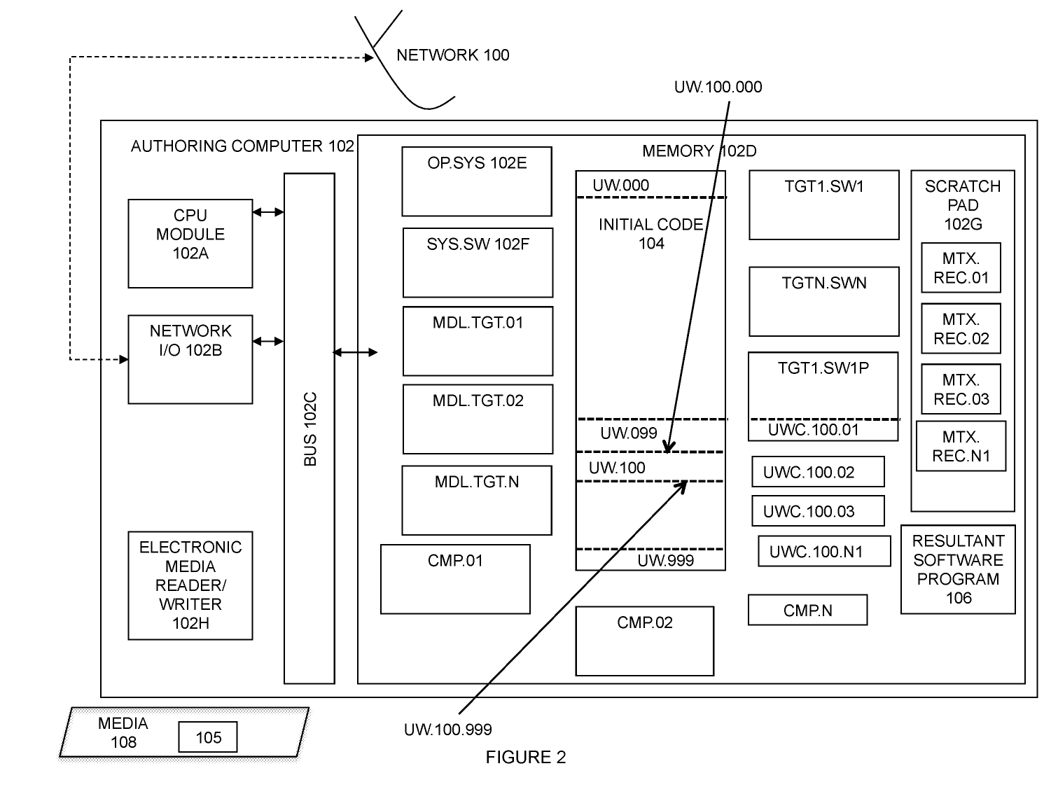

Referring now generally to the Figures, and particularly to FIG. 2, FIG. 2 is a block diagram of the authoring computer 102 of FIG. 1. The authoring computer 102 may be, comprise, or be comprised within a suitable prior art computational system, such as a computational system employing one or more dynamically reconfigurable processor and/or other suitable prior art bundled software and hardware computational device product, such as (a.) a THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a suitable UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; or (e.) other suitable electronic device, wireless communications device, computational system or electronic communications device known in the art.

More particularly, the exemplary authoring computer 102 comprises a CPU module 102A; a network interface module 102B, by which the authoring computer 102 may communicate with the other computers TGT.01-TGT.N of the network 100; a system memory 102C; and a communications bus 102D. The communications bus 102D facilitates communication between the above-designated systems within the authoring computer 102.

The CPU module 102A may optionally be, comprise, or be comprised within a prior art microprocessor such as an ITANIUM™ digital microprocessor as marketed by INTEL Corporation of Santa Clara, Calif., a dynamically reconfigurable processor as disclosed in U.S. Pat. No. 9,158,544, titled “System and method for performing a branch object conversion to program configurable logic circuitry”; U.S. Pat. No. 8,869,123 “System and method for applying a sequence of operations code to program configurable logic circuitry”; U.S. Pat. No. 8,856,768 “System and method for compiling machine-executable code generated from a sequentially ordered plurality of processor instructions”; or U.S. Pat. No. 7,840,777 “Method and apparatus for directing a computational array to execute a plurality of successive computational array instructions at runtime”, and/or one or more other suitable processor or combination of digital or analog processors or microprocessors known in the art.

Within the system memory 102C of the authoring computer 102 are an operating system OP.SYS 102E and a system software SYS.SW 102F, the system software enabling the authoring computer 102 to execute the methods of the present invention as described herein. The operating system OP.SYS 102E of the authoring computer 102 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, or WINDOWS 8™ operating system as marketed by Microsoft Corporation of Redmond, Wash.; or the MAC OS X operating system or iPhone G4 OS™ as marketed by Apple, Inc. of Cupertino, Calif.

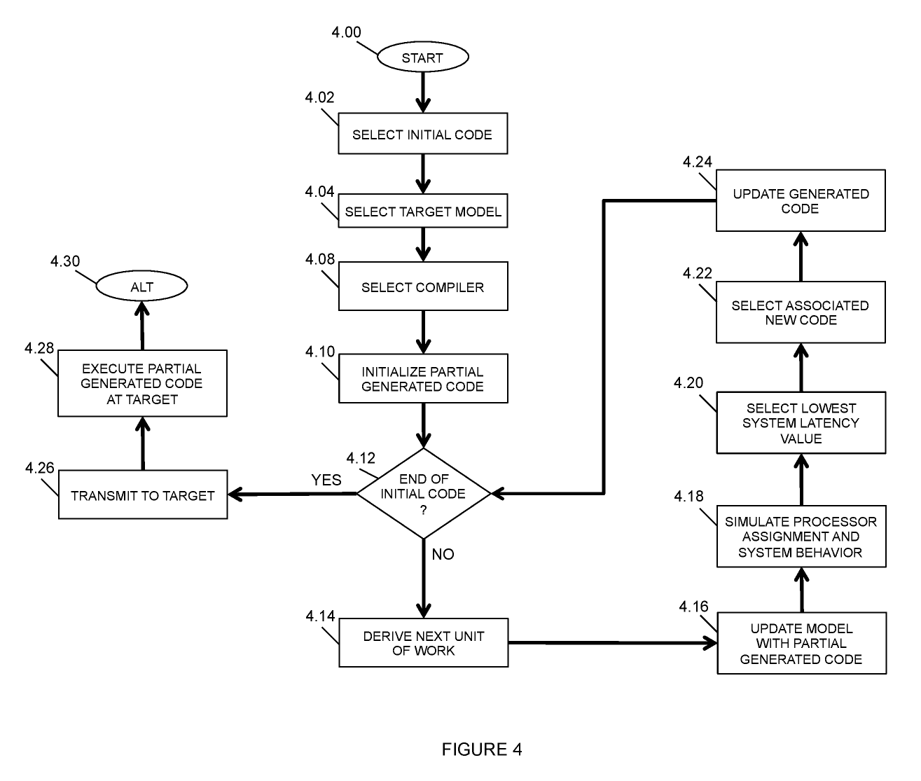

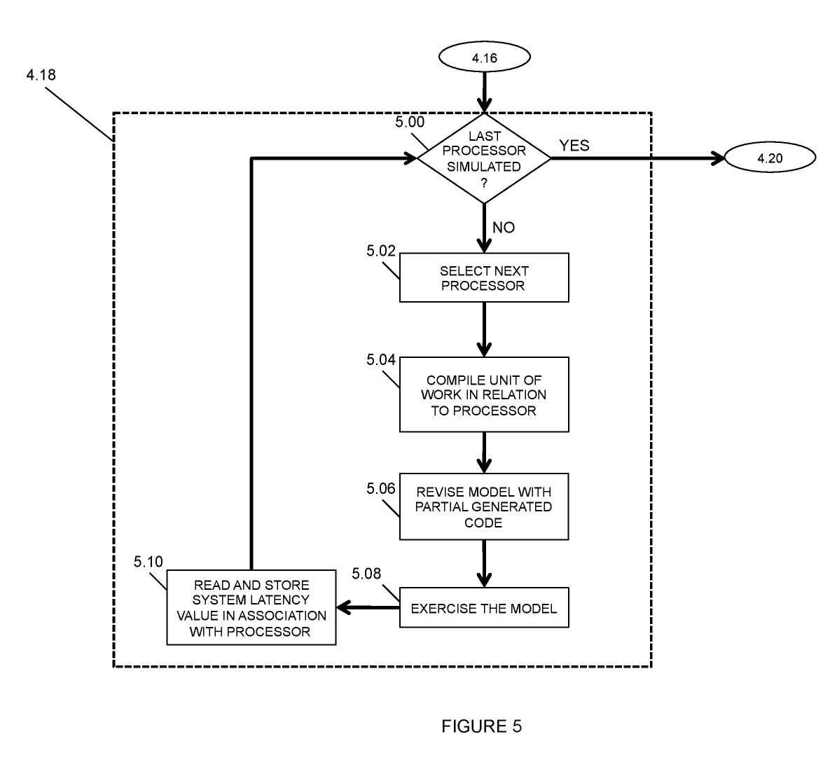

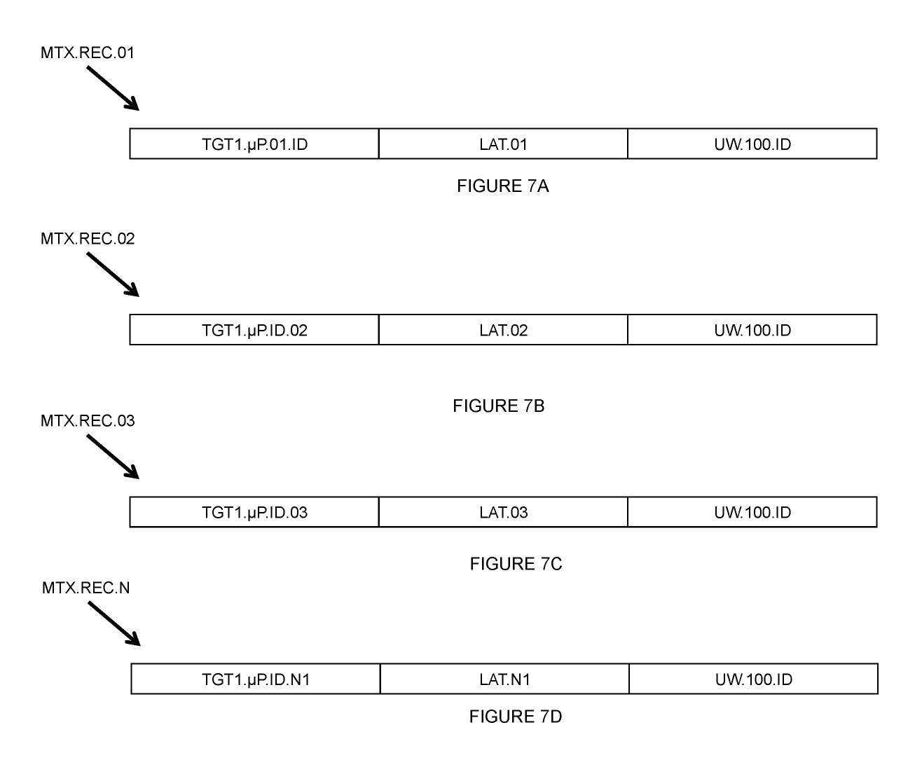

The system memory 102C is shown to contain a plurality of software-encoded target system performance models MDL.TGT.01-MDL.TGT.N, a plurality of target system-specific compiler software CMP.01-CMP.N, a plurality of completed resultant software programs. The system memory 102C further comprises a software scratch pad 102G that contains matrix records MTX.REC.01-MTX.REC.N1, as shown in FIGS. 7A-7D that contain calculated system latency values LAT.01-LAT.N1 applied in support of steps 4.18 and 4.20 of the process of FIG. 4 and step 5.10 of FIG. 5.

It is understood that the initial code 104 may optionally be or include elements of a source code stored in a high-level software language, and/or elements of machine or processor executable code. The system software SYS.SW 102F directs the authoring computer 102 to process and compile a plurality of units of work UW.000-UW.999 as derived from the initial code 104 and written into an exemplary partial resultant software code TGT2.SW2.P, wherein the system software SYS.SW 102F directs the authoring computer 102 to complete the compilation of the exemplary partial resultant software code TGT2.SW2.P whereby the completed resultant software program 106 is generated.

Within the initial code 104 is a top boundary UW.100.000 showing the arbitrarily determined beginning of an exemplary first unit of computational work UW.100 (hereinafter “unit of work UW.100”), and a bottom boundary UW.100.END, showing the arbitrarily determined end of the first unit of work UW.100. It is understood that in accordance with the invented method a plurality of units of work UW.000-UW.099 may be sequentially selected from the software code ordered prior to the top boundary UW.100.000 and compiled into the partial resultant software code. It is further understood that the units of work UW.000-UW.999 as generated by each compiler CMP.01-CMP.N may be unique to the operations of the operative compiler CMP.01-CMP.N.

A unit of work UW.100, as used herein, may be defined as an arbitrarily large and/or small segment of the initial code 104, the logic of which may be applied, or at least purposed to attempt to apply, across a plurality of processors TGT1.μP.01-TGTN.μP.N1 of a plurality of scenarios of execution of one or more target. It is understood that the value “N1” is used within the present disclosure to indicate an arbitrarily large integer value, whereby the number of processors TGT1.μP.01-TGTN.μP.N1 is presented as a function of the actual hardware elements of, respectively, each comprising target computer TGT.01-TGT.N. It is further understood that the value of “N1” has no relationship nor dependency upon the value “N”.

The plurality of target system models MDL.TGT.01-MDL.TGT.N each correspond to one or more of the target computers TGT.01-TGT.N. The invented method enables a generation of each fully compiled resultant code 106 & TGT1.SW1-TGTN.SWN by selecting (a.) the initial code 104; (b.) selecting a target computer TGT.01-TGT.N; (c.) selecting a software-encoded performance target model MDL.TGT.01-MDL.TGT.N corresponding to the selected target computer TGT.01-TGT.N (d.); and applying the system software SYS.SW 102F to process, compile the initial code 104 to generate the resultant code 106 & TGT1.SW1-TGTN.SWN, wherein the resultant code 106 & TGT1.SW1-TGTN.SWN can be executed by the selected target computer TGT.01-TGT.N.

More particularly, an exemplary first compiler CMP.01 accepts the initial code 104, separates sequential units of work UW.000-UW.999 from the initial code 104 by means of exercising the exemplary first target computer model MDL.TGT.01 to generate the first resultant code 106. It is understood that the first target computer model MDL.TGT.01 is adapted to simulate the performance and calculate the system latency of the first target computer TGT.01. It is further understood that first resultant code 106when provided to and executed by the first target computer TGT.01 shall preferably incorporate all the logic required to direct the first target computer TGT.02 to substantively execute, and preferably all of, the logic as encoded in the initial code 104.

As the explanation of the processes of FIGS. 4 and 5 will present an exemplary operation of the first target computer TGT.01, FIG. 2 further presents a first partially compiled software code TGT1.SW1P (hereinafter, “partial code” TGT1.SW!P) that represents a moment in time of the work-in-progress of the first compiler CMP.01 in the process of generating and accreting the partial code TGT1.SW1P to fully generate the exemplary completed resultant code 106. It is understood that resultant code 106 when provided to and executed by the first target computer TGT.01 shall preferably incorporate all the logic required to direct the first target computer TGT.01 to substantively, or preferably completely, execute the logic as encoded in the initial code 104.

Regarding the second exemplary target computer TGT.02, a exemplary second compiler CMP.02 accepts the initial code 104, separates sequential units of work UW.000-UW.999 from the initial code 104 by means of exercising the second target computer model MDL.TGT.02 to generate the second resultant code TGT2. SW2. It is understood that the second target computer model MDL.TGT.02 is adapted to simulate the performance and calculate the system latency of the second target computer TGT.02.

An exemplary Nth compiler CMP.N accepts the initial code 104, separates sequential units of work UW.000-UW.999 from the initial code 104 by means of exercising the Nth target computer model MDL.TGT.N to generate an Nth alternate resultant software code TGTN.SWN. It is understood that the Nth target computer model MDL.TGT.N is adapted to simulate the performance and calculate the system latency of the Nth target computer TGT.N. It is further understood that Nth alternate resultant software code TGTN.SWN when provided to and executed by the Nth target computer TGT.N shall incorporate all the logic required to direct the second target computer TGT.N to execute the logic as encoded in the initial code 104.

It is additionally understood that the limitation of quantity of compilers CMPL.01-CMP.N, target compute models MDL.TGT.01-MDL.TGT.N, resultant code 106 & TGT1.SW1-TGTN.SWN present within the authoring computer 102 and is limited by the memory capacity of the system memory 102C and the operational capabilities of the authoring computer 102.

The authoring computer 102 may optionally further comprise an electronic media reader/writer 102H that is adapted to write digitally encoded software as stored in the authoring computer 102 to a portable electronic media memory device 108. More particularly, the electronic media reader/writer 102H is preferably bi-directionally communicatively with to the CPU module 102A via the communications bus 102B. The authoring computer 102 may thereby may write copies of the initial code 104 and/or one or more of the resultant code 106 & TGT1.SW1-TGTN.SWN, as directed by the authoring system software SYS.SW 102F and/or the authoring computer operating system software OP.SYS.102A, from the system memory 102D and onto the portable electronic media memory device 108. The initial code 104 and/or one or more of the resultant code 106 & TGT1.SW1-TGTN.SWN may thereby be transferred onto other digital computing devices, such as one or more target computers TGT.01-TGT.N.

Referring now generally to the Figures, and particularly to FIG. 3, FIG. 3 is a block diagram of the exemplary first target computer TGT.01 of FIG. 1. The exemplary first target computer TGT.01 comprises a first target CPU module TGT.01A that further includes a plurality of microprocessors TGT1.μP.01-TGT1.μP.N and an optional first target network interface module TGT.01B. The first target network interface module TGT.01B preferably enables the first target computer TGT.01 to bi-directionally communicate with the authoring computer 102 via the electronic communications network 100 and additionally the remaining additional target computers TGT.02-TGT.N. A first target communications bus TGT.01C facilitates communication among the elements TGT.01A, TGT.01B & TGT.01D of the first target computer TGT.01, to include the plurality of microprocessors TGT1.μP.01-TGT1.μP.N. The plurality of microprocessors TGT1.μP.01-TGT1.μP.N of the first target computer TGT.01 may include at least one dynamically reconfigurable processor TGT1.μP.01. A first target memory TGT.01D of the first target computer TGT.01 includes an first target operating system OP.SYS.TGT.01 and a first target system software SYS.SW.TGT.01, wherein the system software enables the first target computer TGT.01 to execute the first resultant software 106and other aspects of the invented method as described herein as required by the invented method.

The first target computer TGT.01 may optionally include software, aspects and elements enabling the first target computer itself to compile the resultant code 106 from the initial code 104 and thereupon execute the resultant code 104. The first target system software SYS.SW.TGT.01 is optionally adapted to enable and direct the first target computer TGT.01 to both generate the resultant code 106 from the initial code 104 by application of the first target compiler CMP.01 and the first target computer model MDL.TGT.01. Towards this alternate preferred embodiment of the invented method and the invented first target computer TGT.01, the first target compute TGT.01 is configured to include the first target computer compiler CMP.01, the first target computer model MDL.TGT.01 and the initial code 104. The first target memory TGT.01D is adapted to store the resultant code 104 and offers memory resources that enable the generation by the first compiler CMP.01 of the resultant code 106 from the initial code 104. The first target memory TGT.01D is additionally adapted to store the resultant code 106 and to make the resultant code 106 available for execution by the first target computer TGT.01 as directed by the first target system software SYS.SW.TGT.01.

The first target computer TGT.01 may optionally further comprise a target electronic media reader/writer TGT.01E that is adapted to read digitally encoded software from the portable electronic media memory device 108. More particularly, the target electronic media reader/writer TGT.01E is preferably bi-directionally communicatively with to the first target CPU module TGT.01A via the first target communications bus TGT.01C. The first target computer TGT.01 may thereby may receive copies of the initial code 104 and/or one or more of the resultant code 106 & TGT1.SW1-TGTN.SWN as directed by the first target software SYS.SW.TGT.01 and/or the first target computer operating system software OP.SYS.TGT.01 from the portable electronic media memory device 108 and write the received initial code 104 and resultant code 106 & TGT1.SW1-TGTN.SWN into the first target system memory TGT.01D via the via the first target communications bus TGT.01C. The initial code 104 and/or one or more of the resultant code 106 & TGT1.SW1-TGTN.SWN may thus be provided to the first target computer TGT.01.

Referring now to explanatory text presented herein regarding FIG. 4 and offered for clarity of explanation and not as limitation of the invented method, the example of a generation of the first resultant code 106by the first compiler CMP.01 of the initial code 104 by sequential compilations of units of work UW.000-UW.999 is presented, wherein the aspects or the invented method of a generation, selection and accretion of selected additional compiled software code, as delineated and complied by the first compiler CMP.01, onto the partial code TGT1.SW1P is reviewed. It is understood that the aspects of the invented method applied in the generation of the first resultant code 106presented within the present disclosure may be applied by alternate compilers CMP.02-CMP.N to the initial code 104 to generate alternative resultant code TGT2.SW2-TGTN-TGTN.SWN, wherein each alternative resultant code TGT2.SW2-TGTN-TGTN.SWN is adapted and configured to be executed by at least one associated target computer TGT.01-TGT.N.

Referring now generally to the Figures, and particularly to FIG. 4, FIG. 4 is a flow chart of a preferred embodiment of the invented method that may executed by the authoring computer 102 in a generation of the first resultant code 106. It is additionally understood that the methods and aspects of FIGS. 4 and 5 may executed by the authoring computer 102 in the generation of the alternate resultant code TGT2.SW2-TGTN.SWN.

In step 4.02 the initial code 104 is selected. In step 4.04 the first target model MDL.TGT.01 of the first target computer TGT.01 is selected and onto which units of work UW.000-UW.N derived from the initial code 104 may be mapped.

In step 4.08 the first target compiler CMP.01 is selected for processing of the initial code 104. In step 4.10 the partial code TGT1.SW1P is initialized. In step 4.12 the authoring computer 102 determines whether a final element of the initial code 104 has been compiled into the partial code TGT1.SW1P.

When the authoring computer 102 determines in step 4.12 that the final element of the initial code 104 that has previously not been processed by the first compiler CMP.01 and added to the partial code TGT1.SW1P, the authoring computer 102 derives from the initial code 104 a next, not yet processed unit of work UW.000-UW.999 from the initial code 104 in step 4.14. It is understood that in step 4.14 the authoring computer 102 may generate a plurality of alternative software encoded compilations UWC.100.01-UWC.100.N1 of the unit of work UW.000-UW.999, wherein each alternative software encoded compilations UWC.100.01-UWC.100.N1 of the unit of work UW.000-UW.999 is adapted to be performed by either a type of processor or a particular processor TGT1.μP.01-TGT1.μP.N1 of the first target computer TGT.01.

For example and not offered as a limitation, in step 4.14 when the first compiler CMP.01 delineates a 100^{th} unit of work UW.100 that begins at a certain software element UW.100.000 of the initial code 104, the first compiler CMP.01 will determine a following initial code software code element UW.100.999 to be a final and boundary element UW.100.999 of the 100^{th} unit of work UW.100. The first compiler CMP.01 will then generate the plurality of alternative software encoded compilations UWC.100.01-UWC.100.N1, wherein each unit of work alternative software encoded compilations UWC.100.01-UWC.100.N1 (hereinafter, “unit of work compiled code” UWC.100.01-UWC.100.N1), is adapted to be executed by either one type of processor or a particular processor TGT1.μP.01-TGT1.μP.N1 of the first target computer TGT.01.

In step 4.16 the first target model MDL.TGT.01 of the first target computer TGT.01-TGT.N is updated by provision of the current state of the partial code TGT1.SW1P, whereby the first target model MDL.TGT.01 is placed in a logical simulating the probable state achieved by the first target computer TGT.01 after the first target system has executed the logic encoded in the current state of the partial code TGT1.SW1P.

In step 4.18 various scenarios are tested in which assignment of each unit of work compiled code UWC.100.000-UWC.100.N1 is individually applied within a separate scenario as assigned to each processor TGT1.μP.01-TGTN.μP.N1 and each scenario is separately simulated. The simulated behavior and calculated system latency of the overall system regarding the assignment of a particular unit of work UW.000-UW.999 to each the processors TGT1.μP.01-TGTN.μP.N1 is measured and system latency values LAT.01-LAT.N1 are generated, as is described in more detail in the method of FIG. 5, and its accompanying text.

It is understood that in step 4.18, as performed in the case of the first compiler CMP.01 processing the 100^{th} unit or work UW.100, that the plurality of compiled code segments UWC.100.01-UWC.100.N1 are generated, wherein each compiled code segment UWC.100.01-UWC.100.N1 is a compilation of the individual unit of work UW.000-UW.999 formed and selected in step 4.14 that has been compiled and structured to attempt to enable an individual selected processor TGT1.μP.01-TGTN.μP.N1 of the first target computer TGT.01 to fully execute the logic of the unit of work UW.000-UW.999 selected and derived in the most recent instantiation of step 4.14.

By way of illustration and not offered as limitation, FIG. 2 presents aspects and elements of the invented method as applied to the plurality of compiled code segments UWC.100.01-UWC.100.N1 as derived by the first compiler CMP.01 from, and associated with, an exemplary 100^{th} work unit UW.100. It is understood that the 100^{th} work unit UW.100 delineated from the initial code 104, wherein the 100^{th} exemplary work unit UW.100 comprises software code UW.100.000-UW.100.999 sourced from the initial code 104.

It is also understood that the first exemplary compiled code segment UWC.100.01 comprises software code generated by the first target compiler CMP.01 in an exercise of the first target model MDL.TGT.01 in a simulation of an application of the logic of the selected exemplary 100^{th} work unit UW.100 by the first processor TGT1.μP.01. The second exemplary compiled code segment comprises software code generated by the first target compiler CMP.01 in an exercise of the first target model MDL.TGT.01 in a simulation of an application of the logic of the selected exemplary 100^{th} work unit UW.100 by the second processor TGT1.μP.02. The N1th exemplary compiled code segment UWC.100.N1 comprises software code generated by the first target compiler CMP.01 in an exercise of the first target model MDL.TGT.01 in a simulation of an application of the logic of the selected exemplary 100^{th} work unit UW.100 by the N1th processor TGT1.μP.N1.

In step 4.20 the simulation scenario having the lowest system latency value LAT.01-LAT.N1 is determined and in step 4.22 the complied code UWC.100.01-UWC.100.N1 associated with the lowest system latency value LAT.01-LAT.N1 generated in the most recent execution of step 4.18 is elected. In step 4.24 the partial code TGT1.SW1P is updated to include the associated compiled code UWC.100.01-UWC.100.N1 as selected in step 4.22. FIG. 2 indicates a case where the second compiled code UWC.001.02 is added to the code TGT1.partial P.

The authoring computer 102 subsequently returns to step 4.12 and determines again whether the final element of the initial code 104 has been read. When the authoring computer 102 determines in step 4.12 that the final element of the initial code 104 has not been reached, the authoring computer 102 proceeds to step 4.26, wherein the authoring computer 102 transmits the resultant code 106 to the first target computer TGT.01. In step 4.28 the first resultant code 106 is executed by the first target computer TGT.01. The authoring computer 102 executes alternate operations in step 4.30.

Referring now generally to the Figures, and particularly to FIG. 5, FIG. 5 a flowchart providing additional detail in the method of FIG. 4. The authoring computer 102 proceeds from step 4.16 of the method of FIG. 4, to step 5.00, wherein steps 5.00 through 5.10 comprise an expanded, detailed view of step 4.18 of FIG. 4. In step 5.00, the authoring computer 102 determines whether the performance of all selectable processors TGT1.μP.01-TGTN.μP.N1 of the first target computer TGT.01 has been simulated to calculate a system latency value LAT.01-LAT.N1.

When the authoring computer 102 determines in step 5.00 that not all of the processors TGT1.μP.01-TGTN.μP.N1 have been simulated in executing the last selected unit or work UW.100, the authoring computer 102 selects a next processor TGT1.μP.01-TGTN.μP.N1 to be simulated in execution in step 5.02. In step 5.04, the unit of work UW.100 is compiled to generate a compiled unit of work UWC-001.01-UWC.N1 for the processor TGT1.μP.01-TGTN.μP.N1 selected in step 5.02. Because more than one type of processor TGT1.μP.01-TGTN.μP.N1 may be present within one or more of the target computing systems TGT.01-TGT.N, the unit of work UW.100-UW.N is compiled in relation to the selected processor TGT1.μP.01-TGTN.μP.N1 so that the compiler CMP.01-CMP.N may actuate the code comprising the unit of work UW.01-UW.N to be read by the selected type of processor TGT1.μP.01-TGTN.μP.N1.

In step 5.06 the target model MDL.TGT.01-MDL.TGT.N selected in the last execution of step 4.04 is programmed with the partial generated code TGT1.SW1P, and in step 5.08 the target model MDL.TGT.01-MDL.TGT.N selected in step 5.06 is exercised, to simulate the effect of the workload of the processors TGT1.μP.01-TGTN.μP.N1 on the total system efficiency and/or latency values LAT.01-LAT.N1.

In step 5.10 a system latency value LAT.01-LAT.N1 associated with the compiled unit of work UWC.100.01-UWC.100.N1 is by exercising the target computer model MDL.TGT.01-MDL.TGT.N as selected in the last execution of step 4.04 and in simulated application with the processor TGT1.μP.01-TGTN.μP.N1 selected in the most recent execution of step 5.02. The system latency values LAT.01-LAT.N1 in step 5.10 may be stored in association with the TGT1.μP.01-TGTN.μP.N1 selected in the most recent execution of step 5.02 in the scratch pad 102E

The authoring computer 102 subsequently proceeds from step 5.10 to step 5.00, wherein the authoring computer 102 determines when every selectable processor TGT1.μP.01-TGTN.μP.N1 of the target computer TGT.01-TGT.N associated with the target model MDL.TGT.01-MDL.TGT.N selected in the most recent execution of step 4.04 has been simulated in an execution the logic of the most recently formed unit of work UW.000-UW.999. When the authoring computer 102 determines that performance of each processor TGT1.μP.01-TGTN.μP.N1 has been tested of the target computer TGT.01-TGT.N currently being simulated, the authoring computer 102 proceeds to step 4.20 of the method of FIG. 4.

Referring now generally to the Figures, and particularly to FIGS. 4 and 5, it is understood that in certain alternate preferred embodiments of the invented method that in processing the initial code 104, that one or more invented compilers CMP.01-CMP.N may find that there is not particularly a sequential mapping of segments of the initial code 104 to units of work UW.000-UW.999. For example, a same block of source code of the initial code 104, or other software code of the initial code 104, might yield multiple parallel units of work UW.000-UW.999 as generated by the selected invented compiler CMP.01-CMP.N in processing the initial code 104. Optionally, additionally or alternatively, developments occurring within a process of generating a resultant code 106 & TGT1.SW1-TGTN.SWN as executed by one or more compilers CMP.01-CMP.N could cause the instant compiler CMP.01-CMP.N to rewrite, reorganize or reassign units of work UW.000-UW.999 that have been previously written into the partial code TGT1.SW1P.

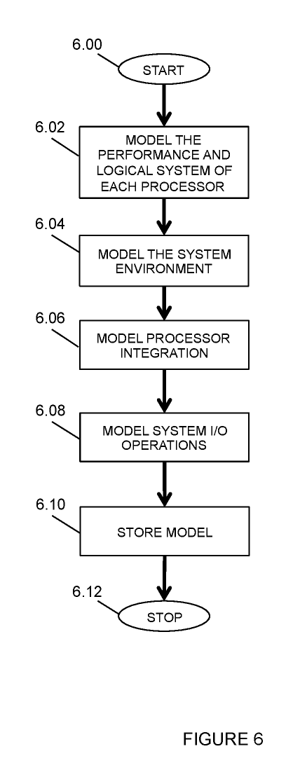

Referring now generally to the Figures, and particularly to FIG. 6, FIG. 6 is a flowchart depicting the process by which a model MDL.TGT.01-MDL.TGT.N is created and saved. In step 6.02 the performance and logic of each processor TGT1.μP.01-TGTN.μP.N1 is modeled of a selected target computer TGT.01-TGT.N. In step 6.04 the system environment, i.e. all elements of the selected target system TGT.01-TGT.N external to each processor TGT1.μP.01-TGTN.μP.N1, are modeled. In step 6.06 the integration of each processor TGT1.μP.01-TGTN.μP.N1 with the remaining elements of the selected target system TGT.01-TGT.N is modeled, and in step 6.08 the system interface interactions selected target system TGT.01-TGT.N are modeled. In step 6.10 the complete model MDL.TGT.01-MDL.TGT.N, integrating a software representation of every necessary aspect of the target computer TGT.01-TGT.N selected in step 6.02 is stored in the memory 102D of the authoring computer 102. In step 6.12 the authoring computer 102 executes alternate operations.

Referring now generally to the Figures, and particularly to FIG. 7A through FIG. 7B, FIG. 7A through FIG. 7D are block diagrams of a plurality of exemplary matrix records MTX.REC.01-MTX.REC.N1. The matrix records MTX.REC.01-MTX.REC.N1 store individual latency values LAT.01-LAT.N in a manner that associates each stored latency value LAT.01-LAT.N with a particular processor TGT1.μP.01-TGT1.μP.01.N or processor type, and a unit of work UWC.100.01-UWC.N from which the instant latency value LAT.01-LAT.N was partially derived.

For example, a first matrix record MTX.REC.01 stores (a.) a first exemplary identifier of TGT1.μP.01.ID that identifies the first particular processor TGT1.μP.01 of the first target computer TGT.01; (b.) a first latency value LAT.01 generated in accordance with the invented method and derived by the authoring computer system software SYS.SW 102F or the first target system software SYS.SW.TGT.01 by application of the first compiled unit of work UW.100.01 with the first compiler CMP.01, the partial code TGT1.SW1P and the first target model MDL.TGT.01; and (c) an exemplary unit of work identifier UW.100.ID ID that identifies the unit of work UW.100 from which the first latency value LAT.01 was derived by the authoring computer system software SYS. SW 102F or the first target system software SYS.SW.TGT.01.

In another example, a second matrix record MTX.REC.02 stores (a.) a second exemplary identifier of TGT1.μP.02.ID that identifies the second particular processor TGT1.μP.02 of the first target computer TGT.01; (b.) a second latency value LAT.02 generated in accordance with the invented method and derived by the authoring computer system software SYS.SW 102F or the first target system software SYS.SW.TGT.01 by application of the second exemplary compiled unit of work UW.100.02 with the first compiler CMP.01, the partial code TGT1.SW1P and the first target model MDL.TGT.01; and (c) an exemplary unit of work identifier UW.100.ID ID that identifies the unit of work UW.100 from which the second latency value LAT.01 was derived by the authoring computer system software SYS.SW 102F or the first target system software SYS.SW.TGT.01.

In yet another example, a third matrix record MTX.REC.03 stores (a.) a third exemplary identifier of TGT1.μP.03.ID that identifies the third particular processor TGT1.μP.03 of the first target computer TGT.01; (b.) a third latency value LAT.03 generated in accordance with the invented method and derived by the authoring computer system software SYS.SW 102F or the first target system software SYS.SW.TGT.01 by application of the third exemplary compiled unit of work CUW.100.03 with the first compiler CMP.01, the partial code TGT1.SW1P and the first target model MDL.TGT.01; and (c) an exemplary unit of work identifier UW.100.ID that identifies the unit of work UW.100 from which the second latency value LAT.01 was derived by the authoring computer system software SYS.SW 102F or the first target system software SYS.SW.TGT.01.

In STILL another example, an N1 matrix record MTX.REC.03 stores (a.) an N1 exemplary identifier of TGT1.μP.03.ID that identifies the n1th particular processor TGT1.μP.03 of the first target computer TGT.01; (b.) an N1 latency value LAT.N1 generated in accordance with the invented method and derived by the authoring computer system software SYS.SW 102F or the first target system software SYS.SW.TGT.01 by application of the N1 exemplary compiled unit of work CUW.100.N1 with the first compiler CMP.01, the partial code TGT1.SW1P and the first target model MDL.TGT.01; and (c) an exemplary unit of work identifier UW.100.ID that identifies the unit of work UW.100 from which the N1 latency value LAT.01 was derived by the authoring computer system software SYS.SW 102F or the first target system software SYS.SW.TGT.01.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. More particularly, the discussion of the process of the FIGS. 4 through 7D, and particularly in the discussion of FIGS. 4 and 5, the steps of generating the resultant code 106 for execution by the exemplary first target computer TGT.01 was highlighted. It is understood that the aspects and steps of FIGS. 4 through 7D of the invented method are generally adapted to direct the authoring computer 102 and/or the first target computer TGT.01 to apply additional compilers CMP.02-CMP.N and models MDL.TGT.02 & MDL.TGT.N to generate alternate machine-executable software, e.g. alternate resultant code TGT2.SW2 & TGTN.SWN, that is executable by alternate target computers TGT.02 & TGT.N having differing system designs, processor types and operational behaviors. It is further understood that additional compilers CMP.02-CMP.N and models MDL.TGT.03 & MDL.TGT.N are organized to specifically address the specific and possibly dissimilar architectures, designs and operational natures of one or more of the other target computers TGT.02-TGT.N.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, one or more computers 102 & TGT.01-TGT.N-referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A computer-implemented method for optimizing compiled code to be run in a data processing environment comprising at least a first processor and a second processor, the method comprising:
a. Assigning a previously derived initial first workload for the first processor and a previously derived initial second workload for the second processor;
b. Accessing a source code;
c. Generating a unit of computational work derived from the source code;
d. Deriving a first system latency value of the first processor by modeling an assignment of the unit of computational work to the first processor in view of both the initial first workload of the first processor and the initial second workload of the second processor;
e. Deriving a second system latency value of the second processor by modeling an assignment of the unit of computational work to the second processor in view of both the initial first workload of the first processor and the initial second workload of the second processor;
f. Assigning the unit of computational work to the first processor when the first system latency value is lower than the second system latency value; and
g. Assigning the unit of computational work to the second processor when the second system latency value is lower than the first system latency value.

2. The method of claim 1, wherein the initial first workload for the first processor is a null workload.

3. The method of claim 1, wherein the initial second workload for the second processor is a null workload.

4. The method of claim 1, wherein the unit of computational work is compiled from the source code.

5. The method of claim 1, wherein the initial first workload for the first processor is compiled from the source code.

6. The method of claim 1, wherein the initial second workload for the second processor is compiled from the source code.

7. The method of claim 1, wherein the unit of computational work comprises an instruction adapted for execution by a dynamically reconfigurable processor.

8. The method of claim 1, wherein the initial first workload for the first processor comprises an instruction adapted for execution by a dynamically reconfigurable processor.

9. The method of claim 1, wherein the initial second workload for the second processor comprises an instruction adapted for execution by a dynamically reconfigurable processor.

10. The method of claim 1, wherein the source code comprises a plurality of instructions adapted for execution by a dynamically reconfigurable processor.

11. The method of claim 1, wherein the source code comprises at least one instruction adapted for execution by a programmable gate array.

12. The method of claim 1, wherein the unit of computational work is heterogeneous and non-vectorizable

13. A computer-method for optimizing compiled code to be run in a multiple-core data processing environment comprising at least a plurality of communicatively coupled processors, the method comprising:
a. Assigning an initial individual workload to each processor;
b. Accessing a source code;
c. Generating a unit of computational work derived from the source code;
d. Deriving a first system latency value of a first processor of the plurality of processors by modeling an assignment of the unit of computational work to the first processor in view of the assigned initial individual workloads of each processor;
e. Deriving a second system latency value of a second processor of the plurality of processors by modeling an assignment of the unit of computational work to the second processor in view of the assigned initial individual workloads of each processor; and
f. Assigning the unit of computational work to the processor of the plurality of processors associated with a lowest system latency value.

14. The method of claim 13, further comprising:
g. deriving a separate system latency value of each processor by modeling an assignment of the unit of computational work to the each processor in view of the assigned initial individual workloads of each processor; and
h. assigning the unit of computational work to the processor associated with the lowest system latency value derived in element g.

15. The method of claim 14, wherein at least one assigned initial workload for the at least one processor is a null workload.

16. The method of claim 14, wherein the unit of computational work is compiled from the source code.

17. The method of claim 14, wherein at least one initial workload for at least one processor is compiled from the source code.

18. The method of claim 14, wherein the unit of computational work comprises an instruction adapted for execution by a dynamically reconfigurable processor.

19. The method of claim 14, wherein at least one initial workload for at least one processor comprises an instruction adapted for execution by a dynamically reconfigurable processor.

20. The method of claim 14, wherein the source code comprises a plurality of instructions adapted for execution by a dynamically reconfigurable processor.

21. The method of claim 14, wherein the source code comprises at least one instruction adapted for execution by a programmable gate array.

22. The method of claim 14, wherein at least two processors are heterogeneous.

23. The method of claim 14, wherein the unit of computational work is heterogeneous and non-vectorizable.

24. A computer computational system comprising at least a first processor and a second processor, the system comprising:
a. Means to assign a previously derived initial first workload for the first processor and a previously derived initial second workload for second processor;
b. Means to access a source code;
c. Means to generate a unit of computational work derived from the source code;
d. Means to derive a first system latency value of the first processor by modeling an assignment of the unit of computational work to the first processor in view of both the initial first workload of the first processor and the initial second workload of the second processor;
e. Means to derive a second system latency value of the second processor by modeling an assignment of the unit of computational work to the second processor in view of both the initial first workload of the first processor and the initial second workload of the second processor;
f. Means to assign the unit of computational work to the first processor when the first system latency value is lower than the second system latency value; and
g. Means to assign the unit of computational work to the second processor when the second system latency value is lower than the first system latency value.

25. The system of claim 24, wherein the first processor and the second processor are homogeneous.

26. The system of claim 24, wherein the first processor and the second processor are heterogeneous.

27. The system of claim 24, wherein at least one processor is a dynamically reconfigurable processor.

28. The system of claim 25, wherein at least one processor comprises a programmable gate array.
